(19) United States
(12) Patent Application Publication
(10) Pub. No.: US 2015/0116697 A1
(43) Pub. Date: Apr. 30, 2015

(54) FIBRE OPTIC TAUT WIRE

(71) Applicant: GE Energy Power Conversion Technology Ltd., Rugby Warwickshire (GB)

(72) Inventor: Richard Ian Stephens, Rugby Warwickshire (GB)

(73) Assignee: GE Energy Power Conversion Technology Ltd., Rugby Warwickshire (GB)

(21) Appl. No.: 14/068,845

(22) Filed: Oct. 31, 2013

(51) Int. Cl. G01B 11/14; G01B 11/16

(52) U.S. Cl. CPC G01B 11/14; G01B 11/165; G02B 6/4427
USPC 356/32

(57) ABSTRACT

A taut cable with a fiber optic cable with Bragg diffusion gratings allows a suitable driver circuit to determine the shape of the taut cable at a large number of points along its length. This enables the total 3-dimensional shape of the taut cable to be estimated and from which the position of the vessel relative to a seabed weight attached to the taut cable can be inferred.

### TECHNICAL FIELD

The technical field relates generally to systems and methods for determining the position of a vessel in the ocean and more specifically a system and method that employs fiber optic technology.

### BACKGROUND

In oceanic prospection, often a ship (vessel) is placed “stationary” near a prospection point in the ocean and it is important to know the position of this ship. For reasons of safety, the ship position must be measured by more than one method that do not share a single mode of failure. One way to determine the ship position is using the global positioning system (GPS) and other method commonly used is the measurement through use of a taut wire.

The principle of the taut wire position measurement system is to keep a wire in constant tension between the vessel and a point on the seabed (this can be a well-head or a weight dropped from the vessel). The tension is maintained by an electric winch that constantly winds wire in and out as the vessel rolls or moves. By measuring the angles from vertical at the top, the position of the vessel relative to the seabed weight can be estimated as shown in FIG. 1. FIG. 1 is an illustration 100 of a ship floating in the ocean with a taut wire (wire rope) connecting from the ship to a seabed weight (sinker weight). When the taut wire is extended (straight), the angle can be measured through an inclinometer attached to the arm of a storage winch. A simple trigonometric calculation will determine the relative position of the ship to the seabed weight.

In suitable water depths, the taut wire measurements are very good, very stable, and different taut wire systems are largely independent of each other. As the water depth increases, though, the ability to keep the taut wire straight is reduced. The weight of a very long taut wire means that the tension at the top increases with increasing depth, while the tension at the bottom is likely to decrease. Currents and tides will also tend to distort the shape of the taut wire. The deepest useful depth for current taut wire systems is about 600 m. Attempts to reduce the effect of current have included measuring the angle at the top and bottom of the wire, but this does not overcome the problems of diverse current profiles (shown in FIG. 2).

The taut wire position measurement system described above is not practical when the depth of the ocean is deep or when the surface current and the sub-surface current flow in different directions. Therefore, it is to a system and method that enables measurement of the relative position of a ship even when the taut wire is not extended the present invention is primarily directed.

### SUMMARY

In one embodiment, the present invention is a method for determining a relative position of a vessel in an ocean to a sinker weight dropped to the seabed. The method includes lowering a taut cable with a fiber optic cable from the vessel into the ocean, receiving by a controller strain data from a plurality of sensor connectors connected to the fiber optic cable, determining a 3D shape of the fiber optic cable, and determining the relative position of the vessel based on the 3D shape.

In another embodiment, the present invention is an apparatus for determining a relative position of a vessel in an ocean to a sinker weight dropped to the seabed. The apparatus includes a taut cable, a fiber optic cable with multiple fiber optic cores attached to the taut cable, a plurality of sensor connectors, each sensor connector being connected to a fiber optic core, a controller connected to the plurality of sensor connectors, and a winch for winding the taut cable with the fiber optic cable. The plurality of sensor connectors are configured to receive strain data from the fiber optic cores and the controller is configured to calculate a 3D shape of the taut cable when the taut cable is dropped into the ocean and to determine the position of the vessel relative to the sinker weight based on the 3D shape.

The foregoing has broadly outlined some of the aspects and features of the various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

FIG. 1 is a prior art schematic depicting a system for determining a ship position;

FIG. 2 is a schematic depicting a difficult situation where the present invention can be employed;

FIG. 3 is a simple illustration of a fiber optic cable attached to a taut wire;

FIG. 4 is an alternative embodiment of a fiber optic cable attached to a taut wire;

FIG. 5 is a flowchart of a process for calculating a position of a ship relative to a seabed weight; and

FIG. 6 is a block diagram of an apparatus for calculating a position of a ship relative to a seabed weight.

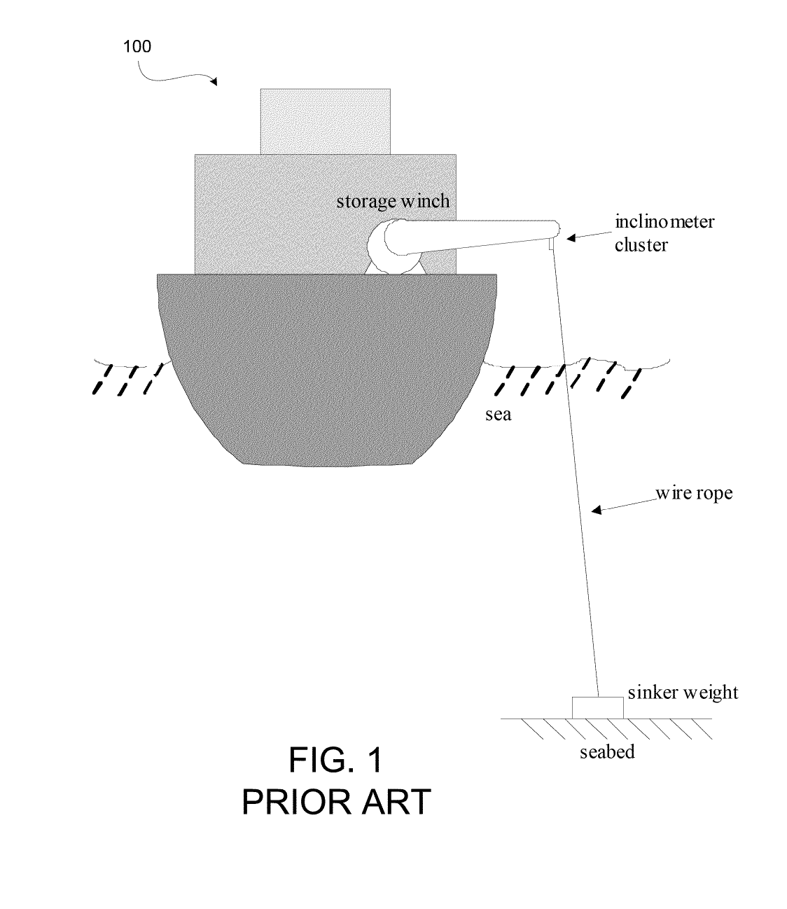

### DETAILED DESCRIPTION OF THE INVENTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

The present invention introduces a system for calculating the relative position of a ship to a seabed weight by using a taut wire with a fiber optic cable. The fiber optic cable has multiple cores with Bragg diffusion gratings that allow a suitable driver circuit to determine the three dimensional (3D) shape of the cable based on the data collected from a large number of points along the length of the fiber optic cable. Using this 3D shape of the fiber optic cable, the position of the ship relative to the seabed weight can be inferred. Because the full shape of the taut wire is measured through the 3D shape of the fiber optic cable, there is no longer a need to keep the taut wire stiff along its length. The tension in the taut wire can therefore be reduced, even down to zero tension at the seabed. In order to reduce the required tension at the top, the length of the wire could include a semi-buoyant sleeve.

The method of calculating the 3D shape of a fiber optic cable is described by U.S. Pat. No. 7,813,599 B2 issued to J. P. Moore on Oct. 12, 2010, the specification of which is incorporated herewith by this reference. The method disclosed by '599 patent uses the estimated bend parameters from a plurality of strain sensors embedded in the light-guiding cores of a fiber optic cable to thereby accurately deduce the shape and end-position of the fiber optic cable. The method uses the natural torsion of the fiber optic cable during bending and the non-summation of strain measurement errors throughout the shape determination process. The method includes calculating various torsion, curvature, and bending direction data solutions in conjunction with an applied curve fitting of the measured curvature and bending direction data to obtain explicitly-defined functional solutions to a set of Frenet-Serret formulas, as those equations are known in the art, thus yielding 3D spatial functions describing the propagation of the fiber optic cable in 3D space. With a fixed end position, the other end position can be determined, and thus the position of an object tethered or connected thereto, e.g., a seabed weight, can be determined.

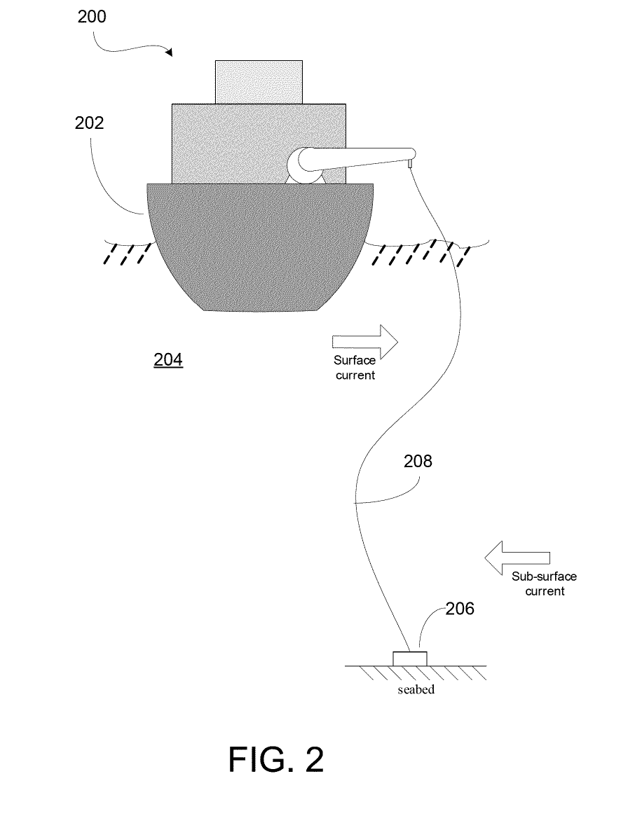

FIG. 2 is a schematic 200 depicting a difficult situation where the present invention can be employed. When a ship 202 is stationed in the deep ocean 204, a sinker weight 206 attached to a special taut wire 208 is dropped to the seabed. Because of the depth of the ocean 204 and the length of the special cable 208, the special taut wire 208 will be subject to different under sea currents. A surface current may flow in a different direction from a sub-surface current as shown in FIG. 2. As consequence, the special taut wire 208 is unlikely to be stretched straight between the ship 202 and the position of the sinker weight 206 on the seabed.

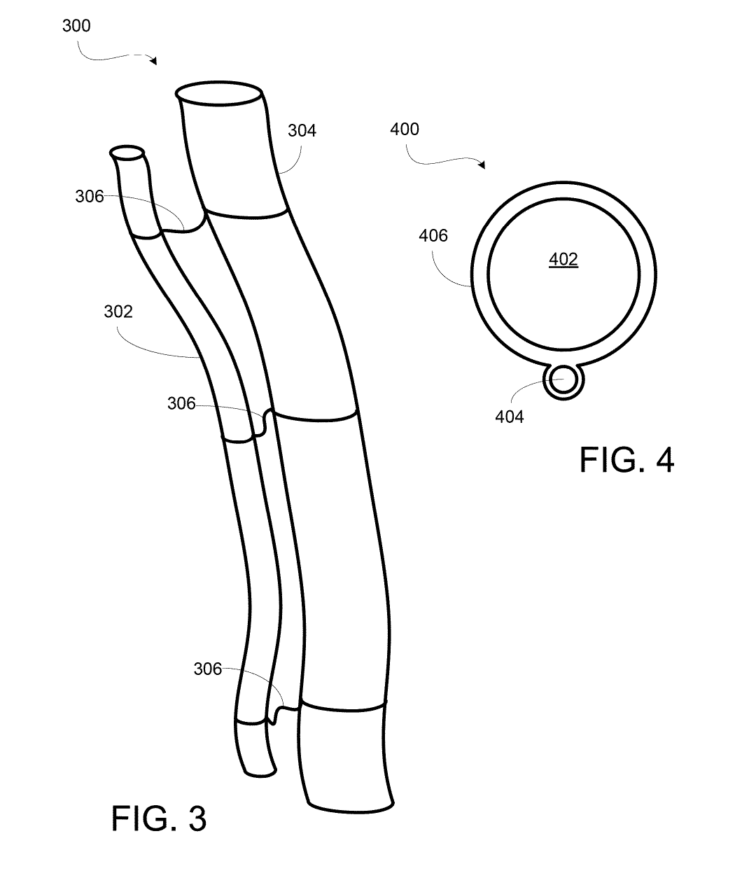

Even with the special taut wire 208 not been stretched straight, the relative position of the ship 202 can be determined using the method described in the '599 patent because of construction of the special taut wire 208. FIG. 3 is an illustration 300 of one embodiment of the special taut wire 208. The special taut wire 208 is composed of a multi-core fiber optic cable 302 attached to a steel taut wire 304. The multi-core fiber optic cable 302 is attached to the steel taut wire 304 through multiples attachment means distributed along the length of the steel taut wire 304. The multi-core fiber optic cable 302 has Bragg diffusion gratings included in its center. The multi-core fiber optic cable 302 has several cores with sensors configured as Fiber Bragg Gratings as described in the '599 patent. The sensors are configured to measure a set of strain data and to relay the set of strain data to a controller and the controller will determine the shape of the optic fiber cable 302 according to the method described in the '599 patent. A laser driver is connected to the multi-core fiber optic cable 302.

FIG. 4 is an illustration 400 for an alternative embodiment for the special taut wire 208. The special taut wire 208 is composed of a fiber optic cable 404 attached to a steel cable 402 and both the fiber optic cable 404 and the steel cable 402 wrapped by a protective layer 406. The protective layer 406 may be rubber, PVC, or other suitable material. Similarly, the fiber optic cable 404 includes several cores with sensors configured as Fiber Bragg Gratings and a controller receives the strain data from the sensors and determines the 3 D shape of the special taut wire 208.

Because the full shape of the taut wire can be determined, there is no longer a need to keep the taut wire stretched and stiff along its length. The tension in the wire can therefore be reduced, even down to zero tension at the seabed. In order to reduce the required tension at the top, the length of the taut wire could include a semi-buoyant sleeve. The laser driver for the fiber optic cable may be mounted on the winch drum.

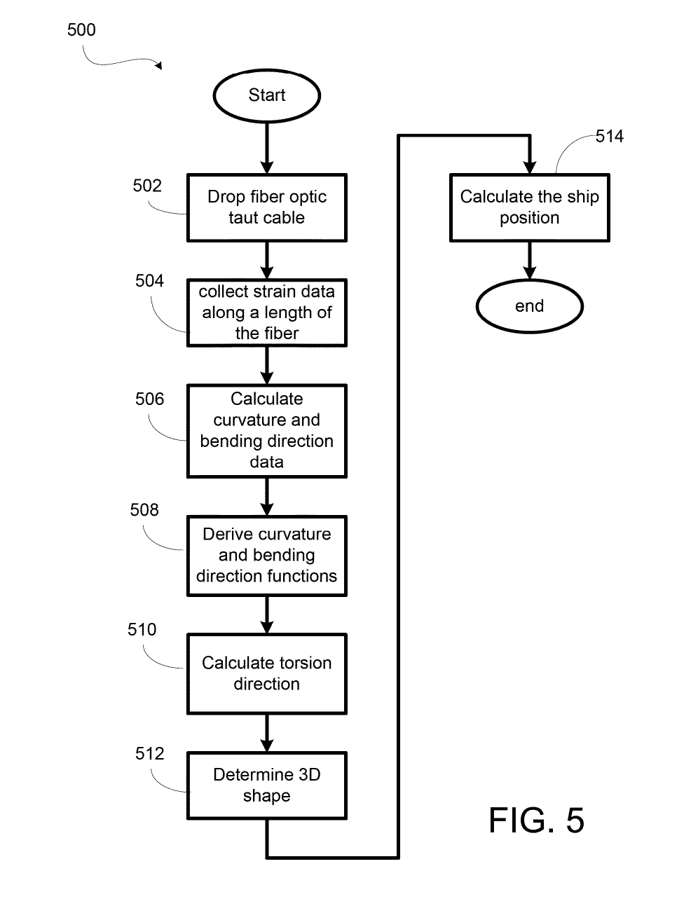

FIG. 5 is a flowchart 500 for a process for calculating the ship position using the present invention. A ship drops the special taut wire with fiber optic cable attached to a seabed weight from a winch, step 502, and collects strain data from the fiber optic cable, step 504. The strain data collected is used to calculate curvature and bending direction data, step 506, and using the curvature and bending direction data to derive curvature and bending direction functions, step 508. The bending direction function is then used to calculate torsion function, step 510. After obtaining the curvature, the bending direction, and the torsion functions, the 3D shape of the fiber optic cable can be determined, step 512. Because the fiber optic cable is attached to the taut wire, the ship position relative to the seabed weight can then be determined, step 514. The details of each calculation steps are further explained in the '599 patent.

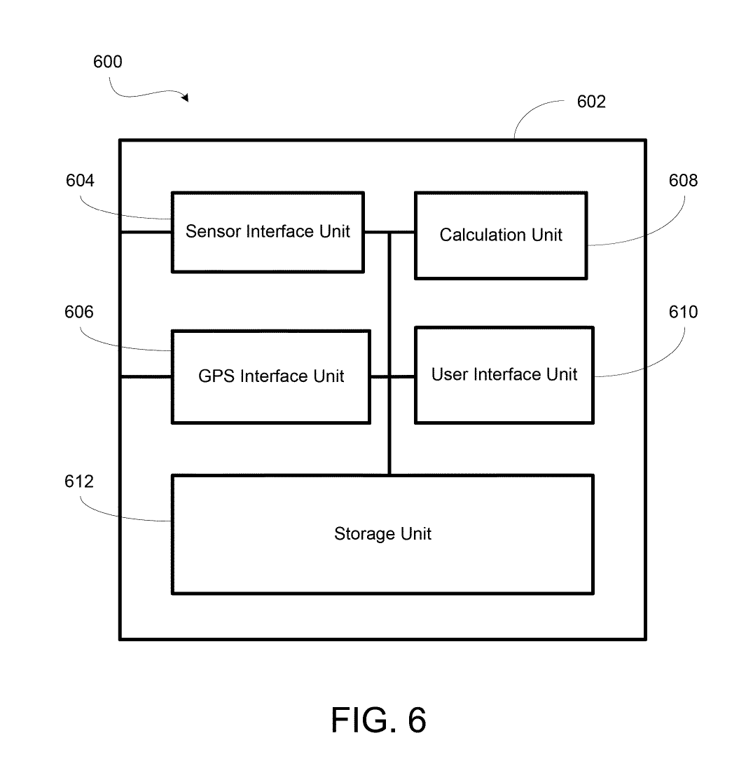

FIG. 6 is a schematic 600 for a controller 602 connected to the fiber optic cable 302. The controller 602 has a sensor interface unit 604 for receiving the strain data from the several cores inside the multi-core fiber optic cable 302, a storage unit 612 for storing the calculation program and also for storing calculation results, a calculation unit 608 for calculating the 3D shape of the multi-core fiber optic cable 302 according to the strain data and also according to the calculation program, and a user interface unit 610 for controlling the interface to a user and also for displaying the calculation result to the user. The storage unit 612 may be a non-transitory tangible computer memory. Optionally, the calculation unit 608 may include a GPS unit 606 for receiving signals from the GPS satellites and for calculating the ship location using the GPS data. The sensor interface unit 604 may have multiple inputs for connecting to multiple cores in the multi-core fiber optic cable 302.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims or if they include equivalent structural elements with insubstantial differences from the literal language of the claims.

What is claimed is:

1. A method, for determining a relative position of a vessel in an ocean to a sinker weight dropped to the seabed, comprising the steps of:
lowering a taut cable with a fiber optic cable from the vessel into the ocean;
receiving, by a controller, strain data from a plurality of sensor connectors connected to the fiber optic cable;
determining a 3D shape of the fiber optic cable; and
determining the relative position of the vessel based on the 3D shape.

2. The method of claim 1, further comprising the step of attaching the fiber optic cable with multiple cores to the taut cable, each core being connected to a sensor connector, each core being connected to a sensor.

3. The method of claim 2, further comprising the step of connecting a plurality of sensor connectors to the controller.

4. The method of claim 1, further comprising the step of attaching the sinker weight to one end of the taut cable.

5. The method of claim 4, wherein the relative position of the vessel is determined relative to the sinker weight.

6. The method of claim 1, further comprising the step of attaching semi-buoyant sleeves to the taut cable.

7. The method of claim 1, further comprises the steps of:
calculating a curvature and bending direction data from the strain data;
deriving a curvature and bending direction functions from the curvature and bending direction data; and
calculating a torsion direction.

8. The method of claim 1, wherein the taut cable and the fiber optic cable are wrapped by a protective layer.

9. The method of claim 8, wherein the protective layer is made from PVC.

10. An apparatus, for determining a relative position of a vessel in an ocean to a sinker weight dropped to the seabed, comprising:
a taut cable;
a fiber optic cable, with multiple fiber optic cores, attached to the taut cable;
a plurality of sensor connectors, each sensor connector being connected to a fiber optic core;
a controller connected to the plurality of sensor connectors; and
a winch for winding the taut cable with the fiber optic cable,
wherein the plurality of sensor connectors are configured to receive strain data from the fiber optic cores and the controller is configured to calculate a 3D shape of the taut cable when the taut cable is dropped into the ocean and to determine the position of the vessel relative to the sinker weight based on the 3D shape.

11. The apparatus of claim 10, further comprising a plurality of semi-buoyant sleeves attached to the taut cable.

12. The apparatus of claim 10, wherein the controller further comprising a non-transitory tangible computer memory for storing computer instructions.

13. The apparatus of claim 12, wherein the computer instructions, when executed by the controller, causes the controller to receive strain data from the fiber optic cores and the controller is configured to calculate a 3D shape of the taut cable when the taut cable is dropped into the ocean and to determine the position of the vessel relative to the sinker weight based on the 3D shape.

14. The apparatus of claim 10, further comprising a laser driver connected to the fiber optic cable.
